(19) United States
(12) Patent Application Publication
(10) Pub. No.: US 2018/0187810 A1
(43) Pub. Date: Jul. 5, 2018

(54) SYSTEM, METHOD AND APPARATUS FOR TOOL-LESS, PRE-ASSEMBLED RESTRAINED JOINT FOR PIPE

(71) Applicant: North American Pipe Corporation, Houston, TX (US)

(72) Inventor: Roy L. Dean, Schwenksville, PA (US)

(21) Appl. No.: 15/853,242

(22) Filed: Dec. 22, 2017

Related U.S. Application Data
(60) Provisional application No. 62/442,266, filed on Jan. 4, 2017.

(51) Int. Cl. F16L 37/088; F16L 21/03; F16L 21/035

(52) U.S. Cl. CPC F16L 37/088; F16L 21/035; F16L 21/03

(57) ABSTRACT

Systems, methods and components for a tool-less, pre-assembled restrained joint for a pipe are disclosed. For example, a pipe can include a tubular member having an axis, a spigot on one axial end, a bell on an opposite axial end, an outer retainer groove in an outer surface of the spigot, and an inner retainer groove in an inner surface of the bell. A retainer comprising a split ring can be configured to be mounted in the inner retainer groove. The retainer can include a single annular finger cantilevered therefrom and circumscribing an entirety of the split ring in spring bias. The finger can be configured to engage the outer retainer groove of a second pipe in a pipe assembly.

This application claims priority to and the benefit of U.S. Prov. Pat. App. No. 62/442,266, filed on Jan. 4, 2017, which is incorporated herein by reference in its entirety.

### BACKGROUND OF THE INVENTION

### Field of the Disclosure

The present invention relates in general to pipes and, in particular, to a system, method and apparatus for a tool-less, pre-assembled restrained joint for a pipe.

### Description of the Prior Art

Conventional spline-type, restrained pipe joint systems typically have splines that are separate from the pipes. The splines can be lost during transportation or disassembly. Examples of such designs include U.S. Pat. No. 5,662,360, U.S. Pat. No. 7,284,310, and U.S. Pat. No. 7,537,248. There are no “push to lock” type pipe joints that rely on a spline that automatically “expands” to open, and then snaps into place. Some users would prefer a quicker installation of restrained joint pipe that does not require “reversibility” (i.e., the ability to take the joint apart after assembly), and yet still provide a robust pipe joint system. Thus, improvements in pipe restrained joints continue to be of interest.

### SUMMARY

Embodiments of a system, method and apparatus for a tool-less, pre-assembled restrained joint for pipes are disclosed. For example, a pipe can comprise a tubular member having an axis, a spigot on one axial end, a bell on an opposite axial end, an outer spline groove in an outer surface of the spigot, and an inner spline groove in an inner surface of the bell. A spline comprising a split ring can be configured to be mounted in the inner spline groove. The spline can include a single annular finger cantilevered therefrom and circumscribing an entirety of the split ring in spring bias. The finger can be configured to engage the outer spline groove of a second pipe in a pipe assembly.

In an alternate embodiment, a coupling can comprise a tubular member having an axis, a receptacle on each axial end, and an inner spline groove in an inner surface of each receptacle. A spline comprising a split ring can be configured to be mounted in each inner spline groove. Each spline can include a single annular finger cantilevered therefrom and circumscribing an entirety of the split ring in spring bias. The finger can be configured to engage an outer spline groove of a respective pipe in a pipe assembly.

Embodiments of a pipe joint system can comprise first and second pipes, each having an axis, a spigot on one axial end, a bell on an opposite axial end, an outer spline groove in an outer surface of the spigot, and an inner spline groove in an inner surface of the bell. A spline comprising a split ring can be configured to be in each inner spline groove. Each spline can include a single annular finger cantilevered therefrom and circumscribing an entirety of the split ring in spring bias. T finger of one of the pipes can be configured to engage the outer spline groove of the other of the pipes.

Another pipe joint system can comprise a coupling having an axis, a receptacle on each axial end, and an inner spline groove formed in an inner surface of each receptacle. A spline can be configured to be in each inner spline groove. Each spline can have a finger for engaging respective first and second pipes

A method of forming a pipe joint can include providing first and second pipes, each having an axis, a spigot on one axial end, a bell on an opposite axial end, an outer spline groove in an outer surface of the spigot, an inner spline groove in an inner surface of the bell, and a spline comprising a split ring in each inner spline groove; axially moving the spigot of the first pipe into the bell of the second pipe, such that a single annular finger of the spline of the second pipe cantilever springs radially outward relative to the axis; and axially aligning the outer spline groove of the first pipe with the inner spline groove of the second pipe, such that the single annular finger of the second pipe cantilever springs radially inward to engage the outer spline groove of the first pipe and form the pipe joint.

Another method of forming a pipe joint can comprise providing a coupling having an axis and a receptacle on each axial end, an inner spline groove in an inner surface of each receptacle, and a spline comprising a split ring in each inner spline groove; providing first and second pipes, each having a pipe axis, a spigot on each axial end, an outer spline groove formed in an outer surface of each spigot; axially moving one spigot of each pipe into a respective receptacle of the coupling, such that a single annular finger of each spline of the coupling cantilevers radially outward relative to the axis; and axially aligning a respective outer spline groove of said each pipe with the respective inner spline groove of the coupling, such that each single annular finger cantilevers radially inward to engage the outer spline groove of a respective pipe and form the pipe joint.

The foregoing and other objects and advantages of these embodiments will be apparent to those of ordinary skill in the art in view of the following detailed description, taken in conjunction with the appended claims and the accompanying drawings.

### BRIEF DESCRIPTION OF THE DRAWINGS

So that the manner in which the features and advantages of the embodiments are attained and can be understood in more detail, a more particular description can be had by reference to the embodiments thereof that are illustrated in the appended drawings. However, the drawings illustrate only some embodiments and therefore are not to be considered limiting in scope as there can be other equally effective embodiments.

FIG. 1 is an isometric view of an embodiment of a portion of a pipe with a retainer installed.

FIG. 2 is an isometric view of an embodiment of a spline.

FIG. 3 is a sectional side view of an embodiment of a coupling assembled to two pipes.

FIG. 4 is an enlarged, sectional, isometric view of an embodiment of a pipe assembly showing the spline in a locked position.

FIGS. 5-7 are sequential, sectional side views of an embodiment of a pipe moving from an uninstalled position, to an intermediate position, to an installed position, respectively, relative to another pipe.

FIG. 8 is a sectional side view of another embodiment of a pipe assembly having more than one spline.

FIG. 9 is an isometric view of a portion of an alternate embodiment of a pipe with a spline installed on an exterior thereof.

FIG. 10 is a sectional side view of the pipe of FIG. 9 installed in the bell of another pipe.

FIG. 11 is a sectional side view of an alternate embodiment of a pipe in an uninstalled position relative to another tubular member.

FIG. 12 is a sectional side view of the embodiment of FIG. 11 in an installed position relative to another tubular member.

The use of the same reference symbols in different drawings indicates similar or identical items.

### DETAILED DESCRIPTION

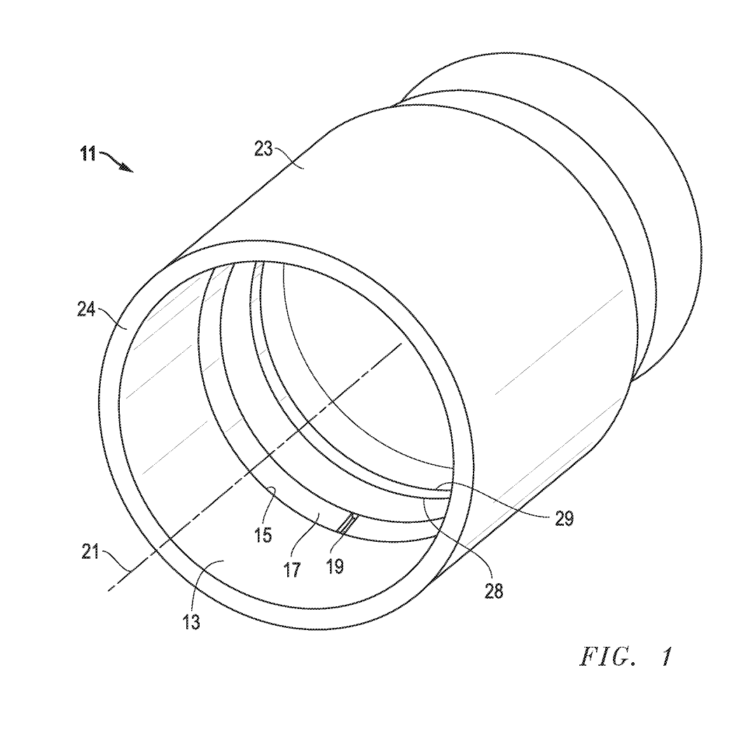

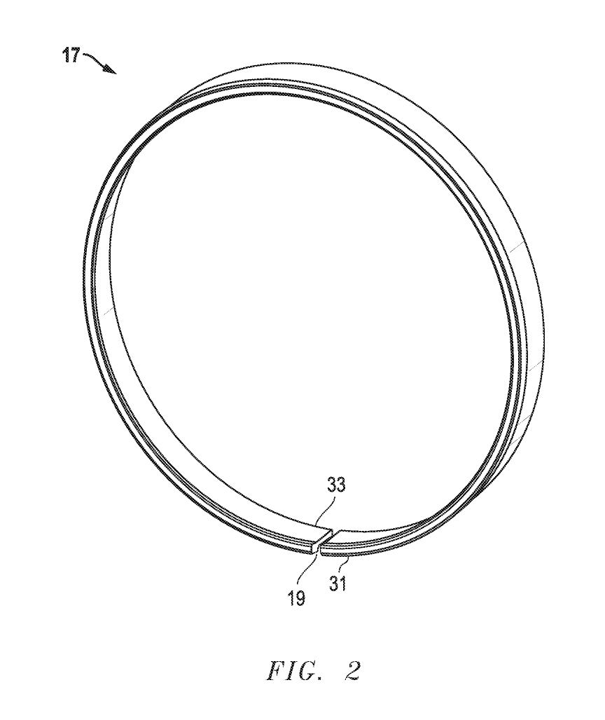

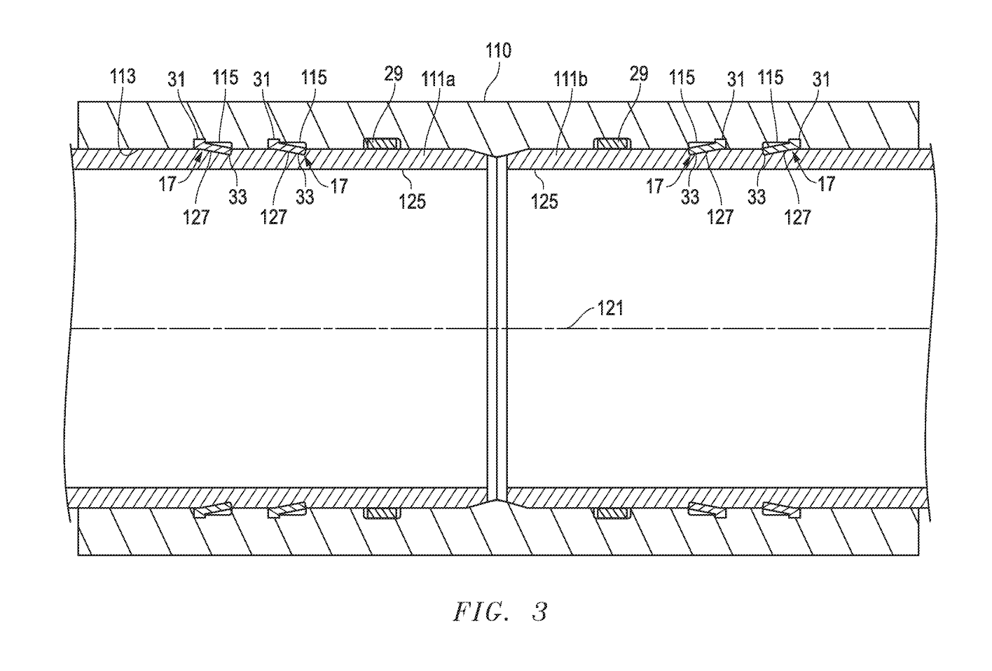

FIG. 1 depicts an isometric view of an embodiment of a portion of a tubular member, such as a pipe 11. The pipe 11 can include a receptacle 13 with a spline groove 15 therein. A retainer, such as a spline 17 (FIGS. 1 and 2), can be located in the spline groove 15. Although receptacle 13 is shown on pipe 11, other embodiments can include another type of tubular member, such as a coupling 110 (FIG. 3) with receptacles 113 on axial ends thereof.

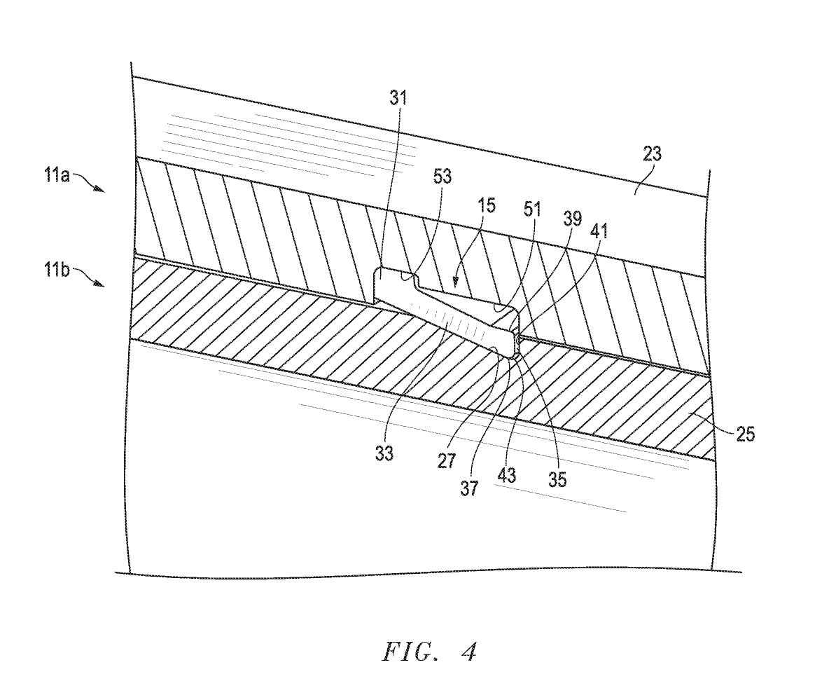

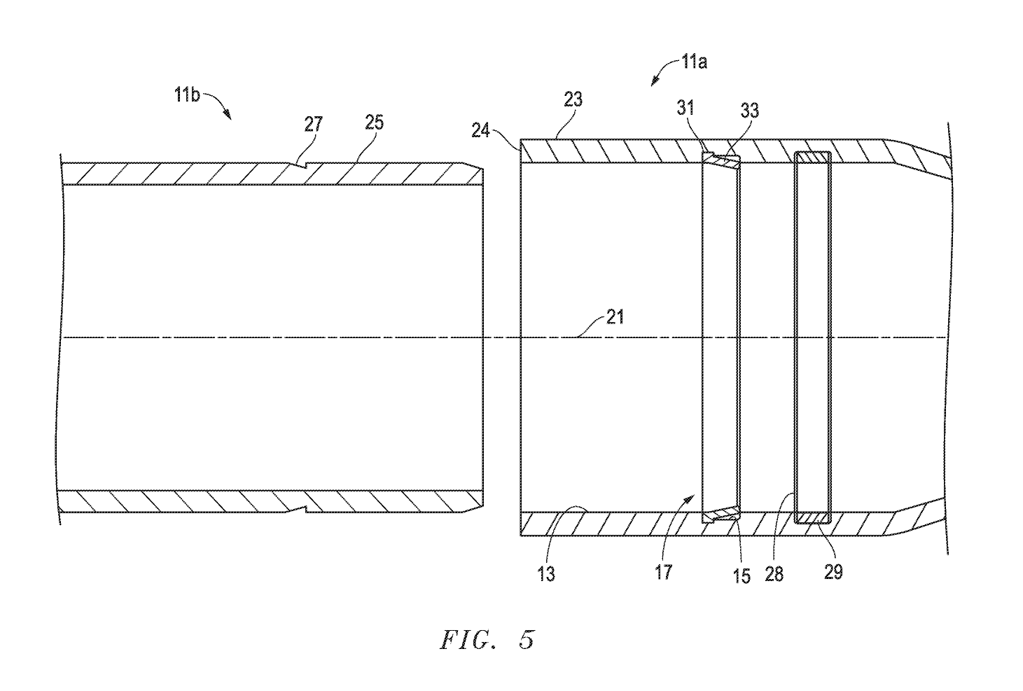

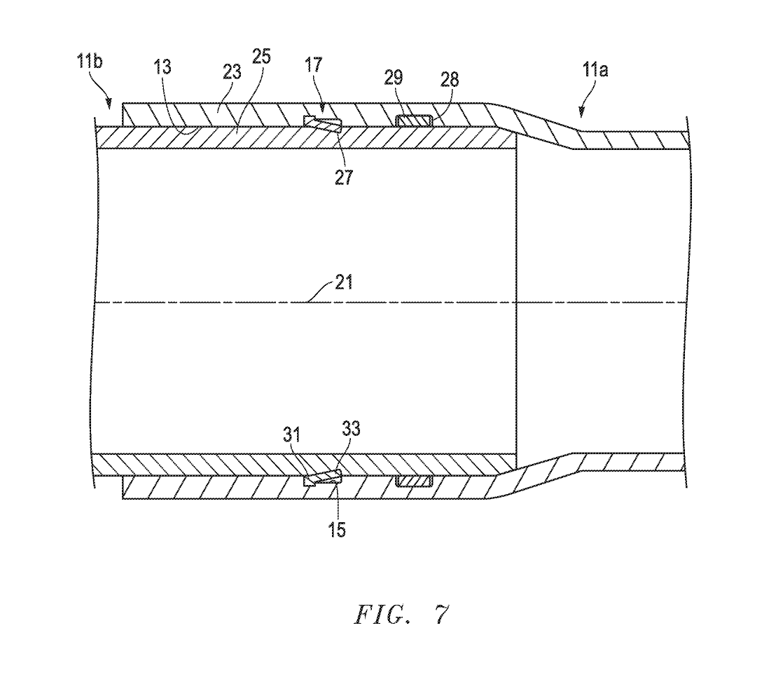

Embodiments of pipe 11 can include an axis 21 (FIG. 1), a bell 23 (in which is located the receptacle 13) on one axial end, and a spigot 25 (on pipe 11b in FIGS. 4 and 5) on an opposite axial end. The spigot 25 can have an outer spline groove 27 in an outer surface thereof the spigot. As shown in FIG. 5, the inner surface of the bell 23 and the outer surface of the spigot 25 can have respective, substantially constant diameters, other than the inner spline groove 15 and the outer spline groove 27, respectively. In addition, the inner diameters of pipes 11a, 11b can be substantially constant and equal (FIG. 7), other than at bells 23. The bell 23 can further include a seal or gasket groove 28 configured to retain a seal or gasket 29.

In some embodiments, the spline 17 comprises a split ring having a single discontinuity 19 (FIGS. 1 and 2). As shown in FIGS. 2 and 4, the spline 17 can include a base 31. Base 31 can comprise a generally rectangular shape in radial section relative to the axis 21. A finger 33, such as a single annular finger, can extend and be cantilevered from base 31. The finger 33 can circumscribe an entirety of the spline 17 in spring bias. The finger 33 can extend diagonally (see FIGS. 4 and 5) relative to the base 31 and axis 21. Embodiments of the finger 33 can terminate in a shoulder 35 (FIG. 4) that is flat and does not have an annular groove in a trailing edge tip thereof. The shoulder 35 can be perpendicular to the axis 21. The finger 33 can include a trailing portion with an outer radial edge 37, relative to the axis 21, that is radiused or chamfered. The trailing portion of finger 33 also can include an inner radial edge 39, relative to the axis 21, that is tapered radially inward.

The finger 33 of spline 17 in pipe 11a (FIGS. 4 and 7) can be configured to engage the outer spline groove 27 of a second pipe 11b in a pipe assembly. Examples of the outer spline groove 27 (FIG. 4) on the spigot 25 can include a tapered surface, a shoulder 41 that extends to the outer surface, and a corner 43 located between the tapered surface of groove 27 and the shoulder 41. The corner 43 can be radiused or chamfered.

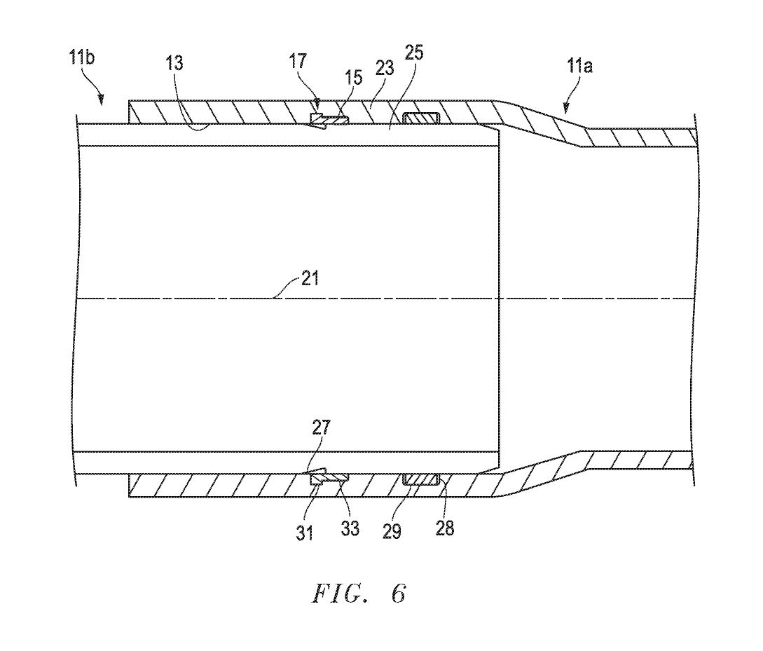

As shown in FIG. 4, the inner spline groove 15 of bell 23 can include a plurality of depths for the spline 17. Embodiments of the inner spline groove 15 can comprise a radial (relative to axis 21) shallow groove 51 located axially further from the axial end 24 (FIG. 1) of the bell 23. Inner spline groove 15 also can have a radial deep groove 53 located between the shallow groove 51 and the axial end 24. The base 31 of the spline 17 can be seated in the deep groove 53. As shown in FIG. 6, the finger 33 can be configured to temporarily seat in the shallow groove 51 when the bell 23 of the pipe 11a initially receives the spigot 25 of the second pipe 11b, prior to reaching the assembled or locked position (FIG. 7).

In some versions, the inner spline groove 15 can be formed in the bell 23 by pressing the spline 17 into the receptacle 13 during the belling process used to form the bell 23. Alternatively, inner spline groove 15 can be machined into the bell 23.

One embodiment of a pipe joint system can include first and second pipes 11a, 11b (FIGS. 4-7), each having an axis 21, a spigot 25 on one axial end, a bell 23 on an opposite axial end, an outer spline groove 27 in an outer surface of the spigot 25, and an inner spline groove 15 in an inner surface of the bell 23. A spline 17 can be configured to be located in each inner spline groove 15. Each spline 17 can have a finger 33 cantilevered therefrom in spring bias, such that the finger 33 extending from pipe 11a is configured to engage the outer spline groove 27 of pipe 11b.

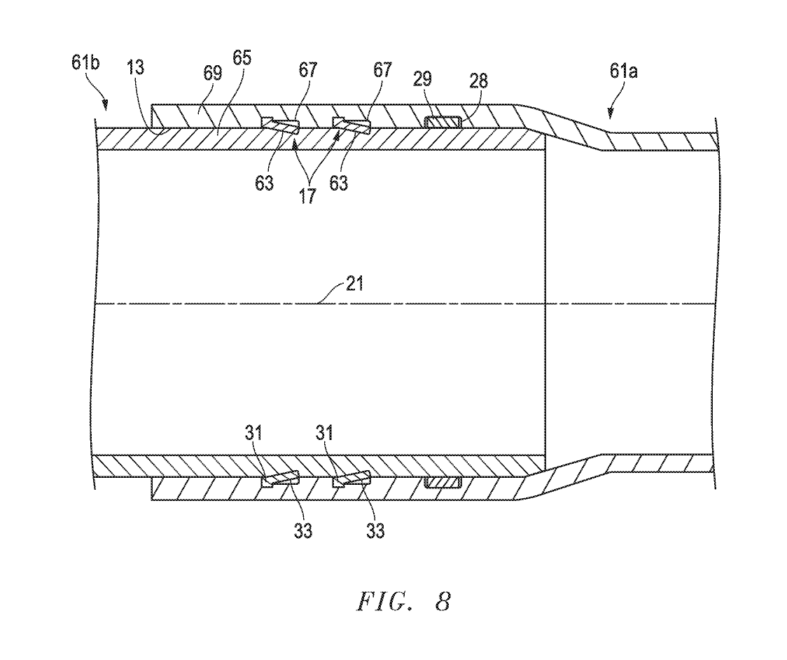

In another embodiment, pipes 61a, 61b (FIG. 8) each can comprise a plurality of outer spline grooves 63 formed in the outer surface of the spigot 65, and a plurality of inner spline grooves 67 formed in the inner surface of the bell 69. For such versions, a plurality of splines 17 (with bases 31 and fingers 33) can be configured to be mounted in respective ones of the inner spline grooves 67 and operate and function as described herein for other embodiments. Seals 29 and seal grooves 28 also can be included.

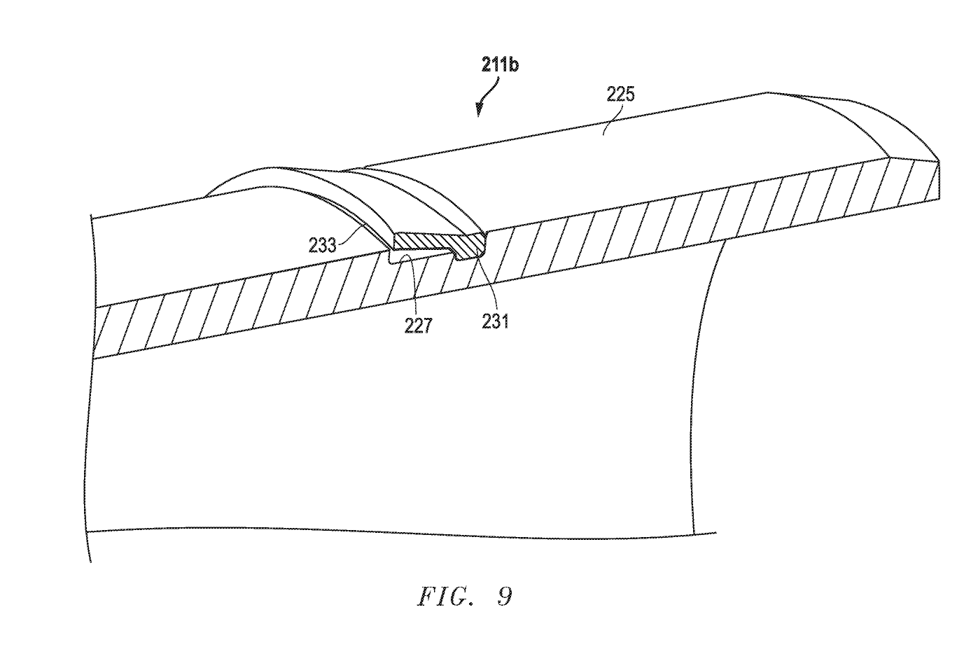

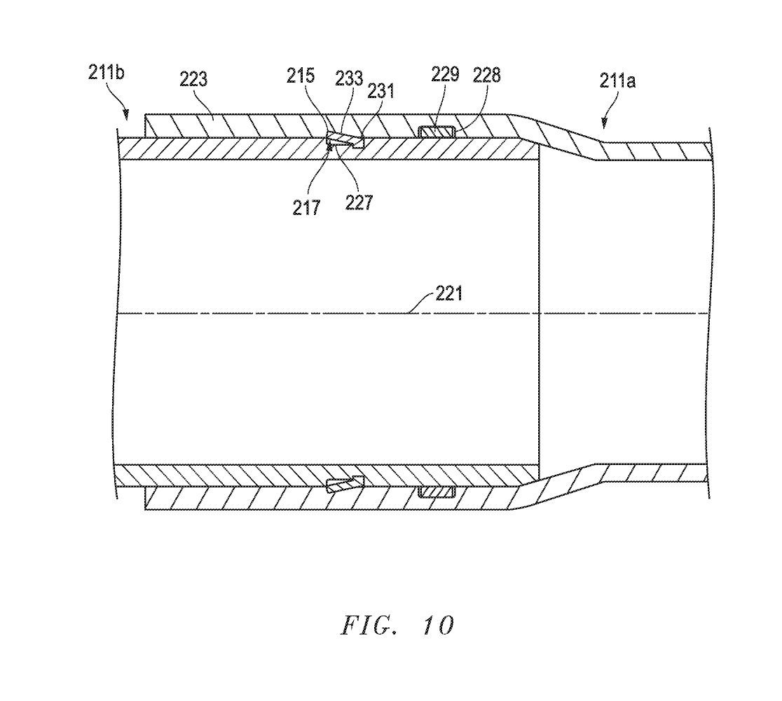

In an alternate embodiment, the base 231 (FIGS. 9 and 10) of a spline 217 can be mounted to the spigot 225 of pipe 211b in a spline groove 227, such that the finger 233 is configured to extend radially outward (relative to axis 221) to engage the inner spline groove 215 of the bell 223 of pipe 211a and function as described herein for other embodiments. In addition, a seal 229 can be provided in a seal groove 228 in bell 223 of pipe 211a.

As previously noted, the coupling 110 (FIG. 3) is an alternate form of the tubular member. Similar to the pipes described herein, the coupling 110 can include an axis 121, a receptacle 113 on each axial end, and one or more inner spline grooves 115 (e.g., two shown on each axial end) in an inner surface of each receptacle 113. A spline 17 having base 31 (previously described) can be configured to be mounted in each inner spline groove 115. The finger 33 of each spline 17 can be configured to engage an outer spline groove 127 of a respective pipe 111a, 111b in a pipe assembly comprising at least two pipes 111 connected to each coupling 110. Pipes 111a, 111b differ from pipes 11, since pipes 11 have bells 23, and pipes 111a, 111b have two spigots 125 and no bells. Alternatively, the integrated bell pipes 11 could be used. Coupling 110 also can comprise an elbow, a tee, or another form of a pipe connector as is known in the art. Coupling 110 also can employ seals 29.

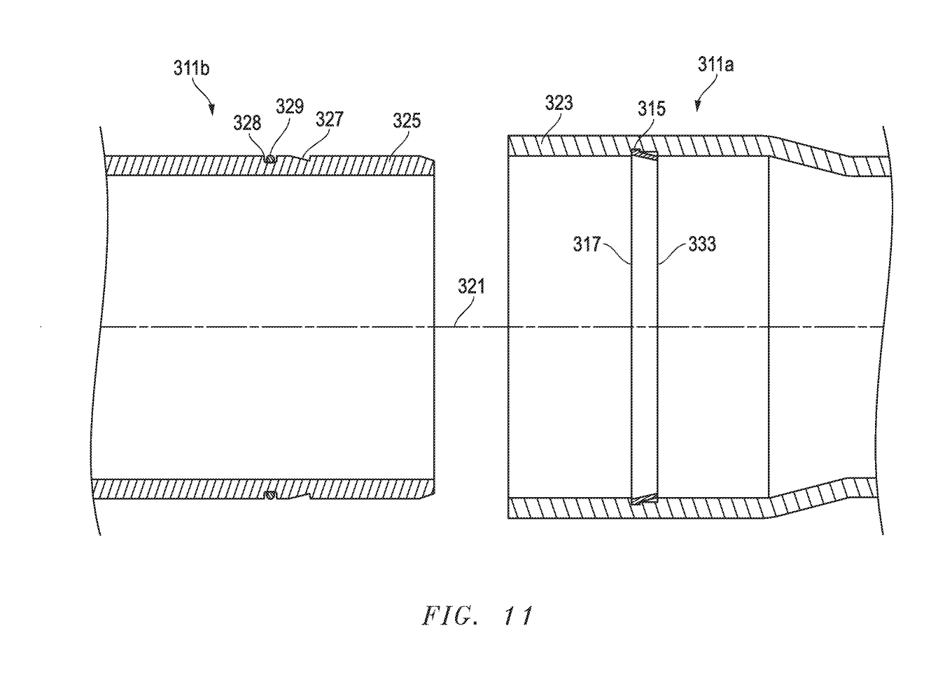

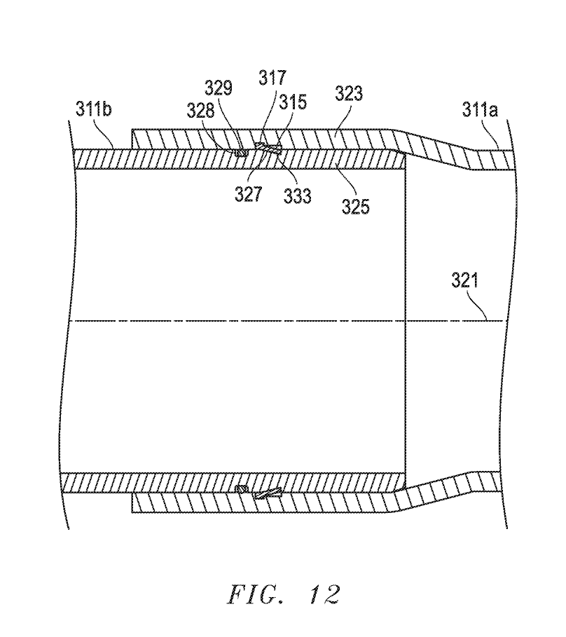

An alternate embodiment of a pipe joint system is illustrated in FIGS. 11 and 12. Versions can include first and second tubular members, such as pipes 311a, 311b, each having an axis 321, a spigot 325 on one axial end, a bell 323 on an opposite axial end, an outer retainer groove 327 in an outer surface of the spigot 325, and an inner retainer groove 315 in an inner surface of the bell 323. A retainer 317 can be configured to be located in each inner spline groove 315. Each retainer 317 can have a finger 333 cantilevered therefrom in spring bias, such that the finger 333 extending from pipe 311a is configured to engage the outer spline groove 327 of pipe 311b. In addition, a seal 329 can be provided in a seal groove 328 in an outer surface of pipe 311b to seal against the inner surface of bell 323.

Embodiments of a method of forming a pipe joint also are disclosed. In one example, the method can include providing first and second pipes, each having an axis, a spigot on one axial end, a bell on an opposite axial end, an outer spline groove in an outer surface of the spigot, an inner spline groove in an inner surface of the bell, and a spline comprising a split ring in each inner spline groove. The method also can include axially moving the spigot of the first pipe into the bell of the second pipe, such that a single annular finger of the spline of the second pipe cantilever springs radially outward relative to the axis. In addition, the method can comprise axially aligning the outer spline groove of the first pipe with the inner spline groove of the second pipe, such that the single annular finger of the second pipe cantilever springs radially inward to engage the outer spline groove of the first pipe and form the pipe joint.

In another embodiment, the method can further comprise forming a gasket seal between the first and second pipes to seal the pipe joint. Examples of the method can further comprise axially abutting a spline flat shoulder at a trailing end tip of the single annular finger against an outer spline groove flat shoulder in the second pipe. In versions where each inner spline groove comprises a plurality of groove depths, the method can include moving the single annular finger of the spline of the second pipe into a shallow groove depth. Once the pipe joint is formed, the pipe joint can be configured to be irreversible such that it cannot be unlocked without the use of tools or, in some cases, destroying the pipe joint.

Another method of forming a pipe joint can include providing a coupling having an axis and a receptacle on each axial end, an inner spline groove in an inner surface of each receptacle, and a spline comprising a split ring in each inner spline groove. The method can comprise providing first and second pipes, each having a pipe axis, a spigot on each axial end, an outer spline groove formed in an outer surface of each spigot; axially moving one spigot of each pipe into a respective receptacle of the coupling, such that a single annular finger of each spline of the coupling cantilevers radially outward relative to the axis during insertion of the pipes; and axially aligning a respective outer spline groove of said each pipe with the respective inner spline groove of the coupling, such that each single annular finger cantilevers radially inward to engage the outer spline groove of a respective pipe and form the pipe joint. Other versions can include method options described herein.

Methods of forming a pipe can include providing a tubular member having an axis, and inner and outer diameters that are substantially constant; placing a spline on a mandrel, the spline having first and second thicknesses and axially inserting the mandrel with the spline into an axial end of the tubular member; heating the tubular member and axially pressing the mandrel and the spline into the tubular member to form a bell on the tubular member, such that the spline also forms a spline groove in the bell and the spline groove has complementary first and second thicknesses to the spline; and then cooling the tubular member and removing the mandrel therefrom such that the spline remains in the spline groove. Versions can further comprise placing a gasket on the mandrel, and axially pressing the mandrel and the gasket to form the bell on the tubular member, such that the gasket also forms a gasket groove in the bell.

Still other versions of a method of forming a coupling can include providing a tubular member having an axis, and inner and outer diameters that are substantially constant; placing a spline on a mandrel, the spline having first and second thicknesses and axially inserting the mandrel with the spline into an axial end of the tubular member; heating the tubular member and axially pressing the mandrel and the spline into the tubular member to form a bell on the tubular member, such that the spline also forms a spline groove in the bell and the spline groove has complementary first and second thicknesses to the spline; and then cooling the tubular member and removing the mandrel therefrom such that the spline remains in the spline groove. An example of the method further comprise placing a gasket on the mandrel, and axially pressing the mandrel and the gasket to form the bell on the tubular member, such that the gasket also forms a gasket groove in the bell.

Still another option is to take an oversized piece of stock and machine away a portion of the inner surface to achieve the desired features to slide over a spigot. Combinations of these various methods can be combined. For example, a pipe or coupling can be belled and then grooves are machined into it in a subsequent operation.

Other versions can include one or more of the following embodiments:

### Embodiment 1

A pipe, comprising:
a tubular member having an axis, a spigot on one axial end, a bell on an opposite axial end, an outer spline groove in an outer surface of the spigot, and an inner spline groove in an inner surface of the bell; and
a spline comprising a split ring configured to be mounted in the inner spline groove, the spline having a single annular finger cantilevered therefrom and circumscribing an entirety of the split ring, the single annular finger being configured to engage the outer spline groove of a second pipe in a pipe assembly.

### Embodiment 2

The pipe of any of these embodiments, wherein the single annular finger extends diagonally relative to the axis.

### Embodiment 3

The pipe of any of these embodiments, wherein the spline comprises a base having a rectangular shape in radial section relative to the axis, and the single annular finger extends from the base.

### Embodiment 4

The pipe of any of these embodiments, wherein the inner surface of the bell and the outer surface of the spigot have respective substantially constant diameters, other than the inner spline groove and the outer spline groove, respectively.

### Embodiment 5

The pipe of any of these embodiments, wherein the bell further comprises a gasket groove configured to retain a gasket.

### Embodiment 6

The pipe of any of these embodiments, wherein the single annular finger terminates in a flat shoulder that does not have an annular groove in a trailing edge tip thereof.

### Embodiment 7

The pipe of any of these embodiments, wherein the single annular finger has a trailing portion with an outer radial edge, relative to the axis, that is radiused or chamfered.

### Embodiment 8

The pipe of any of these embodiments, wherein the single annular finger has a trailing portion with an outer radial edge, relative to the axis, that is tapered radially outward.

### Embodiment 9

The pipe of any of these embodiments, wherein the outer spline groove on the spigot has a tapered surface, a shoulder that extends to the outer surface, a corner located between the tapered surface and the shoulder, and the corner is radiused or chamfered.

### Embodiment 10

The pipe of any of these embodiments, wherein the inner spline groove comprises a plurality of depths for the spline.

### Embodiment 11

The pipe of any of these embodiments, wherein the inner spline groove comprises a plurality of depths formed in the bell by pressing the spline into the tubular member during the belling process used to form the bell.

### Embodiment 12

The pipe of any of these embodiments, wherein the inner spline groove comprises a shallow groove located axially further from the opposite axial end, and a deep groove located between the shallow groove and the opposite axial end.

### Embodiment 13

The pipe of any of these embodiments, wherein the spline comprises a base seated in the deep groove, and the single annular finger is configured to seat in the shallow groove when the bell of the pipe receives a pipe spigot of a second pipe.

### Embodiment 14

The pipe of any of these embodiments, wherein the tubular member comprises a plurality of outer spline grooves formed in the outer surface of the spigot, a plurality of inner spline grooves formed in the inner surface of the bell, and the spline comprises a plurality of splines configured to be mounted in respective ones of the inner spline grooves.

### Embodiment 15

A coupling, comprising:
a tubular member having an axis, a receptacle on each axial end, and an inner spline groove in an inner surface of each receptacle; and
a spline comprising a split ring configured to be mounted in each inner spline groove, each spline having a single annular finger cantilevered therefrom and circumscribing an entirety of the split ring in spring bias, the single annular finger is configured to engage an outer spline groove of a respective pipe in a pipe assembly.

### Embodiment 16

The coupling of any of these embodiments, wherein each single annular finger extends diagonally relative to the axis.

### Embodiment 17

The coupling of any of these embodiments, wherein each spline comprises a base having a rectangular shape in radial section relative to the axis, and the single annular finger extends from the base.

### Embodiment 18

The coupling of any of these embodiments, wherein the inner surface of each receptacle has a substantially constant diameter, other than the inner spline grooves.

### Embodiment 19

The coupling of any of these embodiments, wherein each receptacle further comprises a gasket groove configured to retain a respective gasket.

### Embodiment 20

The coupling of any of these embodiments, wherein each single annular finger terminates in a flat shoulder that does not have an annular groove in a trailing edge tip thereof.

### Embodiment 21

The coupling of any of these embodiments, wherein each single annular finger has a trailing portion with an outer radial edge, relative to the axis, that is radiused or chamfered.

### Embodiment 22

The coupling of any of these embodiments, wherein each single annular finger has a trailing portion with an inner radial edge, relative to the axis, that is tapered radially inward.

### Embodiment 23

The coupling of any of these embodiments, wherein the outer spline groove on each respective pipe has a tapered surface, a shoulder that extends to the outer surface, a corner located between the tapered surface and the shoulder, and the corner is radiused or chamfered.

### Embodiment 24

The coupling of any of these embodiments, wherein each inner spline groove comprises a plurality of depths for a respective spline.

### Embodiment 25

The coupling of any of these embodiments, wherein each inner spline groove comprises a plurality of depths formed in a respective receptacle by pressing a respective spline into the tubular member during a belling process used to form the receptacles as bells.

### Embodiment 26

The coupling of any of these embodiments, wherein each inner spline groove comprises a shallow groove located axially further from a respective axial end of the coupling, and a deep groove located between the shallow groove and the respective axial end.

### Embodiment 27

The coupling of any of these embodiments, wherein each spline comprises a base seated in a respective deep groove, and a respective single annular finger is configured to seat in a respective shallow groove when a respective bell of the coupling receives the respective pipe.

### Embodiment 28

The coupling of any of these embodiments, wherein the tubular member comprises a plurality of inner spline grooves in the inner surface of each receptacle, and the spline comprises a plurality of splines mounted in respective ones of the inner spline grooves.

### Embodiment 29

A pipe joint system, comprising:
first and second pipes, each having an axis, a spigot on one axial end, a bell on an opposite axial end, an outer spline groove in an outer surface of the spigot, and an inner spline groove in an inner surface of the bell; and
a spline comprising a split ring configured to be in each inner spline groove, each spline having a single annular finger cantilevered therefrom and circumscribing an entirety of the split ring in spring bias, and the single annular finger of one of the pipes is configured to engage the outer spline groove of the other of the pipes.

### Embodiment 30

The pipe joint system of any of these embodiments, wherein each single annular finger extends diagonally relative to the axis.

### Embodiment 31

The pipe joint system of any of these embodiments, wherein each spline comprises a base having a rectangular shape in radial section relative to the axis, and the single annular finger extends from the base.

### Embodiment 32

The pipe joint system of any of these embodiments, wherein the inner surface of each bell and the outer surface of each spigot have respective substantially constant diameters, other than the inner spline grooves and the outer spline grooves, respectively.

### Embodiment 33

The pipe joint system of any of these embodiments, wherein each bell further comprises a gasket groove configured to retain a respective gasket.

### Embodiment 34

The pipe joint system of any of these embodiments, wherein each single annular finger terminates in a flat shoulder that does not have an annular groove in a trailing edge tip thereof.

### Embodiment 35

The pipe joint system of any of these embodiments, wherein each single annular finger has a trailing portion with an outer radial edge, relative to the axis, that is radiused or chamfered.

### Embodiment 36

The pipe joint system of any of these embodiments, wherein each single annular finger has a trailing portion with an inner radial edge, relative to the axis, that is tapered radially inward.

### Embodiment 37

The pipe joint system of any of these embodiments, wherein each outer spline groove on a respective spigot has a tapered surface, a shoulder that extends to the outer surface, a corner located between the tapered surface and the shoulder, and the corner is radiused or chamfered.

### Embodiment 38

The pipe joint system of any of these embodiments, wherein each inner spline groove comprises a plurality of depths for a respective spline.

### Embodiment 39

The pipe joint system of any of these embodiments, wherein each inner spline groove comprises a plurality of depths formed in a respective bell by pressing a respective spline into a respective pipe during the belling process used to form each bell.

### Embodiment 40

The pipe joint system of any of these embodiments, wherein each inner spline groove comprises a shallow groove located axially further from a respective axial end, and a deep groove located between the shallow groove and the respective axial end.

### Embodiment 41

The pipe joint system of any of these embodiments, wherein each spline comprises a base seated in a respective deep groove, and each single annular finger is configured to seat in a respective shallow groove when the bell of the first pipe receives the spigot of the second pipe.

### Embodiment 42

A pipe joint system, comprising:
a coupling having an axis, a receptacle on each axial end, and an inner spline groove formed in an inner surface of each receptacle;
a spline comprising a split ring configured to be in each inner spline groove, each spline having a single annular finger cantilevered therefrom and circumscribing an entirety of the split ring in spring bias; and

first and second pipes, each having an outer spline groove in an outer surface thereof, wherein each single annular finger is configured to engage the outer spline groove of a respective one of the pipes.

### Embodiment 43

The pipe joint system of any of these embodiments, wherein each single annular finger extends diagonally relative to the axis.

### Embodiment 44

The pipe joint system of any of these embodiments, wherein each spline comprises a base having a rectangular shape in radial section relative to the axis, and the single annular finger extends from the base.

### Embodiment 45

The pipe joint system of any of these embodiments, wherein the inner surface of each receptacle has a substantially constant diameter, other than the inner spline grooves.

### Embodiment 46

The pipe joint system of any of these embodiments, wherein each receptacle further comprises a gasket groove configured to retain a respective gasket.

### Embodiment 47

The pipe joint system of any of these embodiments, wherein each single annular finger terminates in a flat shoulder that does not have an annular groove in a trailing edge tip thereof.

### Embodiment 48

The pipe joint system of any of these embodiments, wherein each single annular finger has a trailing portion with an outer radial edge, relative to the axis, that is radiused or chamfered.

### Embodiment 49

The pipe joint system of any of these embodiments, wherein each single annular finger has a trailing portion with an inner radial edge, relative to the axis, that is tapered radially inward.

### Embodiment 50

The pipe joint system of any of these embodiments, wherein the outer spline groove on each respective pipe has a tapered surface, a shoulder that extends to the outer surface, a corner located between the tapered surface and the shoulder, and the corner is radiused or chamfered.

### Embodiment 51

The pipe joint system of any of these embodiments, wherein each inner spline groove comprises a plurality of depths for a respective spline.

### Embodiment 52

The pipe joint system of any of these embodiments, wherein each inner spline groove comprises a plurality of depths formed in a respective receptacle by pressing a respective spline into the coupling during a belling process used to form the receptacles as bells.

### Embodiment 53

The pipe joint system of any of these embodiments, wherein each inner spline groove comprises a shallow groove located axially further from a respective axial end of the coupling, and a deep groove located between the shallow groove and the respective axial end.

### Embodiment 54

The pipe joint system of any of these embodiments, wherein each spline comprises a base seated in a respective deep groove, and a respective single annular finger is configured to seat in a respective shallow groove when a respective receptacle of the coupling receives the respective pipe.

### Embodiment 55

A method of forming a pipe joint, comprising:
(a) providing first and second pipes, each having an axis, a spigot on one axial end, a bell on an opposite axial end, an outer spline groove in an outer surface of the spigot, an inner spline groove in an inner surface of the bell, and a spline comprising a split ring in each inner spline groove;
(b) axially moving the spigot of the first pipe into the bell of the second pipe, such that a single annular finger of the spline of the second pipe cantilever springs radially outward relative to the axis; and
(c) axially aligning the outer spline groove of the first pipe with the inner spline groove of the second pipe, such that the single annular finger of the second pipe cantilever springs radially inward to engage the outer spline groove of the first pipe and form the pipe joint.

### Embodiment 56

The method of any of these embodiments, wherein step (c) further comprises forming a gasket seal between the first and second pipes to seal the pipe joint.

### Embodiment 57

The method of any of these embodiments, wherein step (c) further comprises axially abutting a spline flat shoulder at a trailing end tip of the single annular finger against an outer spline groove flat shoulder in the second pipe.

### Embodiment 58

The method of any of these embodiments, wherein each inner spline groove comprises a plurality of groove depths, and step (b) comprises moving the single annular finger of the spline of the second pipe into a shallow groove depth.

### Embodiment 59

The method of any of these embodiments, wherein, once the pipe joint is formed, the pipe joint is irreversible such that it cannot be unlocked without the use of tools.

### Embodiment 60

A method of forming a pipe joint, comprising:
providing a coupling having an axis and a receptacle on each axial end, an inner spline groove in an inner surface of each receptacle, and a spline comprising a split ring in each inner spline groove;
providing first and second pipes, each having a pipe axis, a spigot on each axial end, an outer spline groove formed in an outer surface of each spigot;

1axially moving one spigot of each pipe into a respective receptacle of the coupling, such that a single annular finger of each spline of the coupling cantilevers radially outward relative to the axis; and
axially aligning a respective outer spline groove of said each pipe with the respective inner spline groove of the coupling, such that each single annular finger cantilevers radially inward to engage the outer spline groove of a respective pipe and form the pipe joint.

### Embodiment 61

The method of any of these embodiments, further comprising forming a gasket seal between the coupling and the first and second pipes to seal the pipe joint.

### Embodiment 62

The method of any of these embodiments, further comprising axially abutting a spline flat shoulder at a trailing end tip of each single annular finger against an outer spline groove flat shoulder in a respective pipe.

### Embodiment 63

The method of any of these embodiments, wherein each inner spline groove comprises a plurality of groove depths, and step (b) comprises moving each single annular finger into a respective shallow groove depth.

### Embodiment 64

The method of any of these embodiments, wherein, once the pipe joint is formed, the pipe joint is irreversible such that it cannot be unlocked without using tools.

### Embodiment 65

The pipe of any of these embodiments, further comprising an elastomeric seal configured to provide a fluid tight seal between the bell and a second pipe.

### Embodiment 66

The pipe of any of these embodiments, wherein an elastomeric seal is located in the bell axially inboard of the spline groove.

### Embodiment 67

The pipe of any of these embodiments, wherein when the pipe is assembled with a second pipe, tensile loads applied axially are transferred through the spline to the second pipe.

### Embodiment 68

The pipe of any of these embodiments, wherein when the pipe is assembled with a second pipe, tensile loads applied that would pull an unrestrained assembly apart are supported by the spline to maintain integrity of the assembly.

### Embodiment 69

The pipe of any of these embodiments, wherein when the pipe is assembled with a second pipe, compression loads on the spline are transferred through the assembly by a tapered shoulder in the bell of the pipe interacting with a leading edge of the second pipe.

### Embodiment 70

The coupling of any of these embodiments, wherein compression loads on the splines are transferred through the pipe assembly by respective tapered shoulders in the coupling interacting with respective leading edges of the pipes.

### Embodiment 71

The tubular member of any of these embodiments, wherein the spigot further comprises a seal groove having a seal, and the seal groove is axially outboard of the outer spline groove in the outer surface of the spigot.

### Embodiment 72

The tubular member of any of these embodiments, wherein the bell further comprises a seal groove having a seal, and the seal groove is axially inboard of the inner spline groove in an inner surface of the bell.

### Embodiment 73

The pipe of any of these embodiments, wherein the spigot further comprises a spigot axial end and a seal groove in the outer surface of the spigot, an elastomeric seal is mounted in the seal groove and configured to provide a fluid tight seal, and the seal groove is axially further away from the spigot axial end than the outer retainer groove.

This written description uses examples to disclose the embodiments, including the best mode, and also to enable those of ordinary skill in the art to make and use the invention. The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity can not be required, and that one or more further activities can be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

It can be advantageous to set forth definitions of certain words and phrases used throughout this patent document. The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, can mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C.

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, can also be provided in combination in a single embodiment. Conversely, various features that are, for brevity, described in the context of a single embodiment, can also be provided separately or in any subcombination. Further, references to values stated in ranges include each and every value within that range.

What is claimed is:

1. A pipe, comprising:
a tubular member having an axis, a spigot on one axial end, a bell on an opposite axial end, an outer retainer groove in an outer surface of the spigot, and an inner retainer groove in an inner surface of the bell; and
a retainer comprising a split ring configured to be mounted in the inner retainer groove, the retainer having a single annular finger cantilevered therefrom and circumscribing an entirety of the split ring, the single annular finger being configured to engage the outer retainer groove of a second pipe in a pipe assembly.

2. The pipe of claim 1, wherein the single annular finger extends diagonally relative to the axis.

3. The pipe of claim 1, wherein the retainer comprises a base having a rectangular shape in radial section relative to the axis, and the single annular finger extends from the base.

4. The pipe of claim 1, wherein the bell further comprises a gasket groove configured to retain a gasket.

5. The pipe of claim 1, wherein the single annular finger terminates in a flat shoulder that does not have an annular groove in a trailing edge tip thereof.

6. The pipe of claim 1, wherein the single annular finger has a trailing portion with an inner radial edge, relative to the axis, that is tapered radially inward.

7. The pipe of claim 1, wherein the outer retainer groove on the spigot has a tapered surface, a shoulder that extends to the outer surface, a corner located between the tapered surface and the shoulder, and the corner is radiused or chamfered.

8. The pipe of claim 1, wherein the inner retainer groove comprises a plurality of depths for the retainer.

9. The pipe of claim 1, wherein the inner retainer groove comprises a plurality of depths formed in the bell by pressing the retainer into the tubular member during the belling process used to form the bell.

10. The pipe of claim 1, wherein the inner retainer groove comprises a shallow groove located axially further from the opposite axial end, and a deep groove located between the shallow groove and the opposite axial end.

11. The pipe of claim 1, wherein the spigot further comprises a spigot axial end and a seal groove in the outer surface of the spigot, an elastomeric seal is mounted in the seal groove and configured to provide a fluid tight seal, and the seal groove is axially further away from the spigot axial end than the outer retainer groove.

12. The pipe of claim 1, wherein when the pipe is assembled with a second pipe, tensile loads applied axially are transferred through the retainer to the second pipe.

13. The pipe of claim 1, wherein when the pipe is assembled with a second pipe, tensile loads applied that would pull an unrestrained assembly apart are supported by the retainer to maintain integrity of the assembly.

14. The pipe of claim 1, wherein when the pipe is assembled with a second pipe, compression loads on the retainer are transferred through the assembly by a tapered shoulder in the bell of the pipe interacting with a leading edge of the second pipe.

15. A coupling, comprising:
a tubular member having an axis, a receptacle on each axial end, and an inner retainer groove in an inner surface of each receptacle; and
a retainer comprising a split ring configured to be mounted in each inner retainer groove, each retainer having a single annular finger cantilevered therefrom and circumscribing an entirety of the split ring in spring bias, the single annular finger being configured to engage an outer retainer groove of a respective pipe in a pipe assembly.

16. The coupling of claim 15, wherein each single annular finger extends diagonally relative to the axis.

17. The coupling of claim 15, wherein each retainer comprises a base having a rectangular shape in radial section relative to the axis, and the single annular finger extends from the base.

18. The coupling of claim 15, wherein each receptacle further comprises a gasket groove configured to retain a respective gasket.

19. The coupling of claim 15, wherein each single annular finger has a trailing portion with an outer radial edge, relative to the axis, that is radiused or chamfered.

20. The coupling of claim 15, wherein the outer retainer groove on each respective pipe has a tapered surface, a shoulder that extends to the outer surface, a corner located between the tapered surface and the shoulder, and the corner is radiused or chamfered.

21. The coupling of claim 15, wherein each inner retainer groove comprises a plurality of depths for a respective retainer.

22. The coupling of claim 15, wherein compression loads on the retainers are transferred through the pipe assembly by respective tapered shoulders in the coupling interacting with respective leading edges of the pipes.

23. A pipe joint system, comprising:
first and second pipes, each having an axis, a spigot on one axial end, a bell on an opposite axial end, an outer retainer groove in an outer surface of the spigot, and an inner retainer groove in an inner surface of the bell; and
a retainer comprising a split ring configured to be in each inner retainer groove, each retainer having a single annular finger cantilevered therefrom and circumscribing an entirety of the split ring in spring bias, and the single annular finger of one of the pipes is configured to engage the outer retainer groove of the other of the pipes.

24. The pipe joint system of claim 23, wherein each retainer comprises a base having a rectangular shape in radial section relative to the axis, and the single annular finger extends from the base.

25. The pipe joint system of claim 23, wherein the inner surface of each bell and the outer surface of each spigot have respective substantially constant diameters, other than the inner retainer grooves and the outer retainer grooves, respectively.

26. The pipe joint system of claim 23, wherein each inner retainer groove comprises a plurality of depths for a respective retainer.

27. A pipe joint system, comprising:
a coupling having an axis, a receptacle on each axial end, and an inner retainer groove formed in an inner surface of each receptacle;
a retainer comprising a split ring configured to be in each inner retainer groove, each retainer having a single annular finger cantilevered therefrom and circumscribing an entirety of the split ring in spring bias; and
first and second pipes, each having an outer retainer groove in an outer surface thereof, wherein each single annular finger is configured to engage the outer retainer groove of a respective one of the pipes.

28. The pipe joint system of claim 27, wherein each retainer comprises a base having a rectangular shape in radial section relative to the axis, and the single annular finger extends from the base.

29. The pipe joint system of claim 27, wherein each inner retainer groove comprises a plurality of depths for a respective retainer.
